(19) United States
(12) Patent Application Publication
(10) Pub. No.: US 2009/0199091 A1
(43) Pub. Date: Aug. 6, 2009

(54) System for Electronic Display of Scrolling Text and Associated Images

(76) Inventor: Elmalik Covington, Brooklyn, NY (US)

Correspondence Address: Russ Weinzimmer, 614 Nashua Street, Suite 53, Milford, NH, 03055, US

(21) Appl. No.: 12/363,718

(22) Filed: Jan. 31, 2009

Related U.S. Application Data
(60) Provisional application No. 61/063,148, filed on Feb. 1, 2008.

(51) Int. Cl. G06F 17/21; G06F 3/048; G06F 17/00

(52) U.S. Cl. 715/256; 715/200; 715/716; 715/700

(57) ABSTRACT

A software implemented system is disclosed for displaying scrolling text together with associated graphical images on the display of an electronic device, such as a portable electronic device. The text is displayed preferably in a horizontally scrolling fashion, either above or below the images, and the images are preferably displayed in color. In preferred embodiments, a user can control the scrolling speed, font size, font color, and/or font style, as well as starting, pausing, stopping, backing up, searching for desired text, highlighting text, and setting bookmarks. Some embodiments enable communication with other devices for downloading and/or uploading of reading materials. Preferred embodiments can present music or an audible presentation of the text. These features can enhance the use of the invention as a teaching aid for helping both children and adults to learn to read more quickly, and to aid users in learning a foreign language.

### CROSS-REFERENCES TO RELATED APPLICATIONS

This application is entitled to the benefit of U.S. Provisional Patent Application No. 61/063,148, entitled “MATRIX”, filed Feb. 1, 2008, herein incorporated by reference.

### FIELD OF THE INVENTION

The invention generally relates to electronic display devices, and more specifically to electronic devices for displaying reading materials.

### BACKGROUND OF THE INVENTION

Reading books, magazines, newspapers, and other printed materials can be both enjoyable and educational. In small quantities, most books and other reading materials can be easily transported, and can be read virtually anywhere, including on an airplane, on a train, at a park, at a campsite, and so forth.

However, it is not practical to transport large quantities of books and/or other printed reading materials due to their cumulative weight and bulk. This makes it necessary to select printed reading materials in advance if they are to be read while traveling. In addition, the production of books, magazines, newspapers, and other printed materials consumes valuable natural resources, which are largely wasted if the printed materials are discarded after being read.

One solution is to store books, magazines, newspapers, and other reading materials in a digital format on a portable electronic device that can display the materials on an electronic display when the materials are to be read. Examples include a portable “laptop” computer, an IPod, an MP3 player, a personal digital assistant (“PDA”), a cell phone, a portable electronic game system, a portable DVD player, and many others. This approach allows a large quantity of reading materials to be easily stored and transported, without the need to select specific reading materials in advance, and without the need to dispose of printed materials after they have been read.

However, many books, magazines, newspapers, and other reading materials also include drawings, photographs, and/or other graphical materials that support and enhance the content of the text. When printed on paper, these graphical materials are usually placed near the text to which they relate. However, limitations of page size often require that a reader flip back and forth between pages to as to fully benefit from the graphical materials while reading the text. This problem is even more severe when using a portable electronic device to display reading materials, since portable electronic devices typically include electronic displays that are limited in size and pixel resolution.

### SUMMARY OF THE INVENTION

A software implemented system is claimed for displaying scrolling text together with associated graphical images on the display of an electronic device, which in preferred embodiments is a portable electronic device. A majority of the electronic display is used for presenting graphical images, while only a small portion of the electronic display is used for displaying text. The text is displayed in a horizontally scrolling fashion, either above or below the images. This allows graphical images to be presented using most of the available display resolution, and allows each image to remain viewable so long as text associated with the image is being displayed.

In preferred embodiments, controls are provided that enable control of the scrolling speed of the text, as well as controls that enable selection of materials to be read, selection of font sizes, colors, and styles for the text display. Controls can also be provided for starting, pausing, stopping, backing up, and searching for desired text. Some embodiments enable display of color images, downloading and/or uploading of reading materials, bookmarking of locations within reading materials for later easy return, highlighting of key text within reading materials, and deletion of selected reading materials. Some embodiments can present music or other audible material that enhances the impact of the text.

Preferred embodiments enable control of the speed at which text is scrolled across the display, and certain embodiments can present the text audibly together with the visual display of the text. These features can enhance the use of the invention as a teaching aid for helping both children and adults to learn to read more quickly, and to aid users in learning a foreign language.

The invention is a system for displaying text and associated images. The system includes media containing software that is able to control the actions of an electronic device so as to cause the electronic device to store reading materials in a memory contained in the electronic device, the reading materials including text and at least one graphical image pertaining to the text, display the text on a display of the electronic device, the text being displayed as a scrolling single line of text, and display the at least one graphical image on the display of the electronic device, the at least one graphical image being displayed while text pertaining thereto is simultaneously being displayed.

In preferred embodiments, the electronic device is a portable electronic device. In some preferred embodiments, the electronic device is a desktop computer, a laptop computer, a hand-held computer, a cell phone, a GPS, a smart phone, a game console, a DVD player, and/or an MP3 player.

In certain preferred embodiments the electronic device is able to communicate with other devices over a network. In some of these embodiments the network is one of a local network, the publicly switched telephone network, and the internet. In other of these embodiments the electronic device is able to communicate wirelessly with other devices. In still other of these embodiments the software is able to cause the electronic device to at download reading materials from another device, and/or upload reading materials to another device.

In preferred embodiments, the electronic device is able to display the at least one graphical image in color. In various preferred embodiments the at least one graphical image is a still image or a video image. In some preferred embodiments the scrolling single line of text is displayed horizontally across a bottom of the display. In other preferred embodiments the scrolling single line of text is displayed substantially across a top of the display.

In certain preferred embodiments the software provides user control of a rate of text scrolling, a text font size, a text font style, and/or a text color. In some preferred embodiments the software provides for user control of initiating scrolling of the text, pausing scrolling of the text, halting scrolling of the text, causing the text to scroll rapidly forward, causing the text to scroll rapidly backward, searching the text for a specified word, searching the text for a specified phrase, highlighting text, and/or setting a bookmark at a location in the text so as to enable easy return to the location. And in other preferred embodiments, the software enables a user to select an item of text for display, storing in the memory, deletion from the memory; and/or sharing with another electronic device.

In preferred embodiments the system further includes an electronic device, the software being able to control the actions of the electronic device. In some of these embodiments the electronic device is portable. In other of these embodiments the electronic device is optimized for use by children.

In various preferred embodiments the software is able to cause the electronic device to present audible output in coordination with display of the text. And in certain preferred embodiments the audible output is music unrelated to the text, music coordinated with the text and tending to enhance the effectiveness of the text, and/or an audible presentation of the text coordinated with the visual presentation of the text.

### BRIEF DESCRIPTION OF THE DRAWINGS

The invention will be more fully understood by reference to the detailed description, in conjunction with the following figures, wherein:

FIG. 1A illustrates an embodiment in which the software of the present invention is causing a PDA to display a single line of text from a book below a related graphical image;

FIG. 1B illustrates the embodiment of FIG. 1A a few seconds later, where the text has advanced from right to left;

FIG. 1C illustrates the embodiment of FIG. 1A a few seconds later, where the text has further advanced from right to left;

FIG. 2 illustrates an embodiment in which the software of the present invention is causing an MP3 player to display a single line of text from a magazine article discussing astronomy below a related graphical video;

FIG. 3 illustrates an embodiment that includes an electronic device optimized for teaching children to read and able to present children's stories with variable scrolling speeds and with an audible presentation of the text coordinated with the visual text presentation;

FIG. 4 illustrates an embodiment in which the software of the present invention is causing a computer to display a single line of text from a science textbook below a related scientific diagram, and to highlight items in the diagram as they are referred to by the text.

### DETAILED DESCRIPTION OF PREFERRED EMBODIMENTS

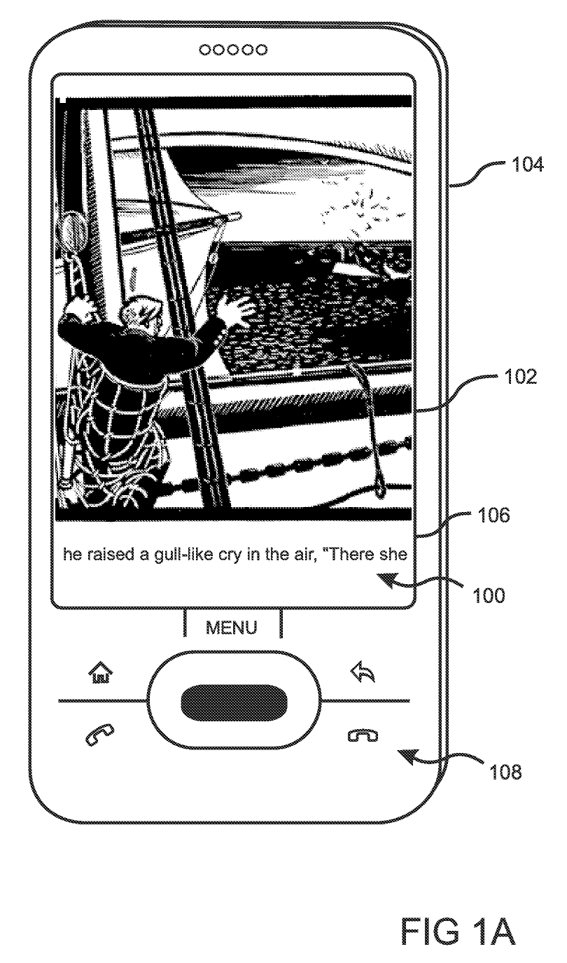

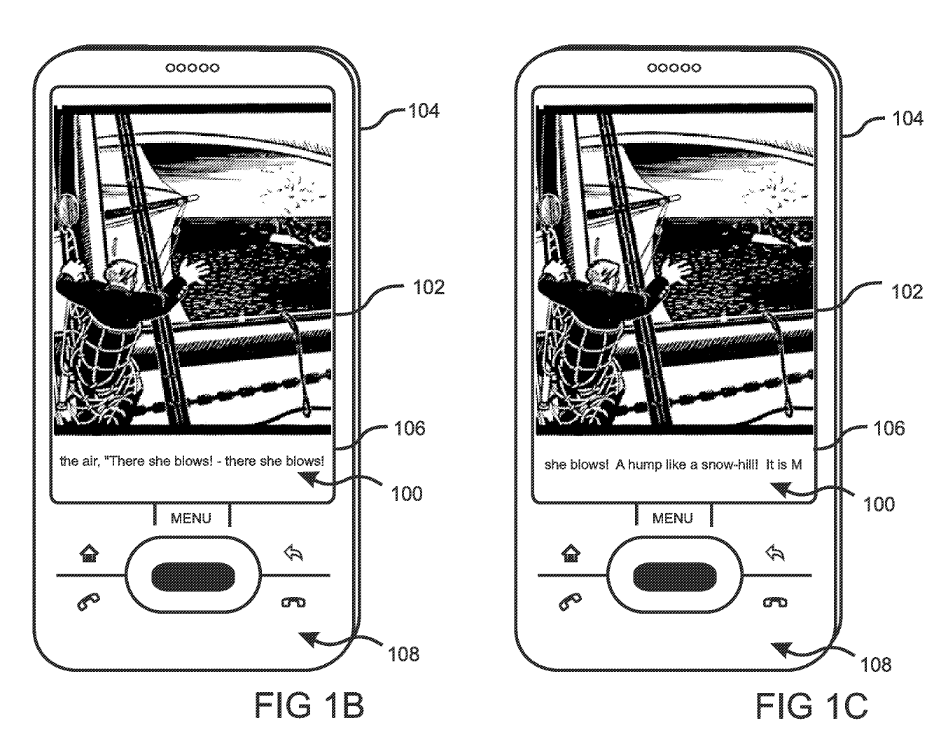

With reference to FIG. 1A, the present invention is a software implemented system for displaying reading materials that include text 100 and associated images 102. The reading materials are displayed on an electronic device 104, that is preferably a portable electronic device 104 such as the PDA 104 shown in FIG. 1A. In FIG. 1A, the text 100 of a book is scrolling from right to left across the bottom of the display 106 of the electronic device 104, while images 102 relating to the text 100 are displayed above the text 100. FIG. 1B illustrates the embodiment of FIG. 1A a few moments later, and FIG. 1C illustrates the embodiment of FIG. 1B a few moments later. The scrolling of the text 100 can be seen by comparison of FIG. 1A with FIG. 1B and FIG. 1C.

The scrolling presentation of the text 100 allows the majority of the screen 106 to be used for displaying images 102, which in preferred embodiments can be color images, and which typically require a much higher display resolution than text 100. Scrolling of the text 100 also allows images 102 to remain on the screen 106 in association with an arbitrary amount of text 100, so long as display of the image 102 is relevant.

Reading materials are stored in a memory included in the electronic device 104, and can be selected and displayed using physical controls 108 included in the device and/or by using a pointing device to actuate controls presented on the display 106. In preferred embodiments, the reading materials can be transferred to and from the electronic device 104 through a direct connection to a computer or other device, by telephone communication, or by wired or wireless communication with other devices, over the network or over the internet. In this regard, embodiments of the present invention are analogous to typical MP3 players, in that MP3 players store, exchange, and play musical recordings, whereas the present invention stores, exchanges, and displays reading materials.

In preferred embodiments, the rate of text scrolling can be controlled. In some embodiments, controls are also provided for initiating, pausing, and halting the text scrolling, as well for moving rapidly forward or backward, searching for specified words or phrases, and setting bookmarks in the text for easy return to the same location at a later time. In the embodiment of FIG. 1A, physical controls 108 included with the electronic device 104 are used to control the display of reading materials. In similar embodiments, software controls presented on the display 106 and actuated using a pointing device are used to control some or all of the display features.

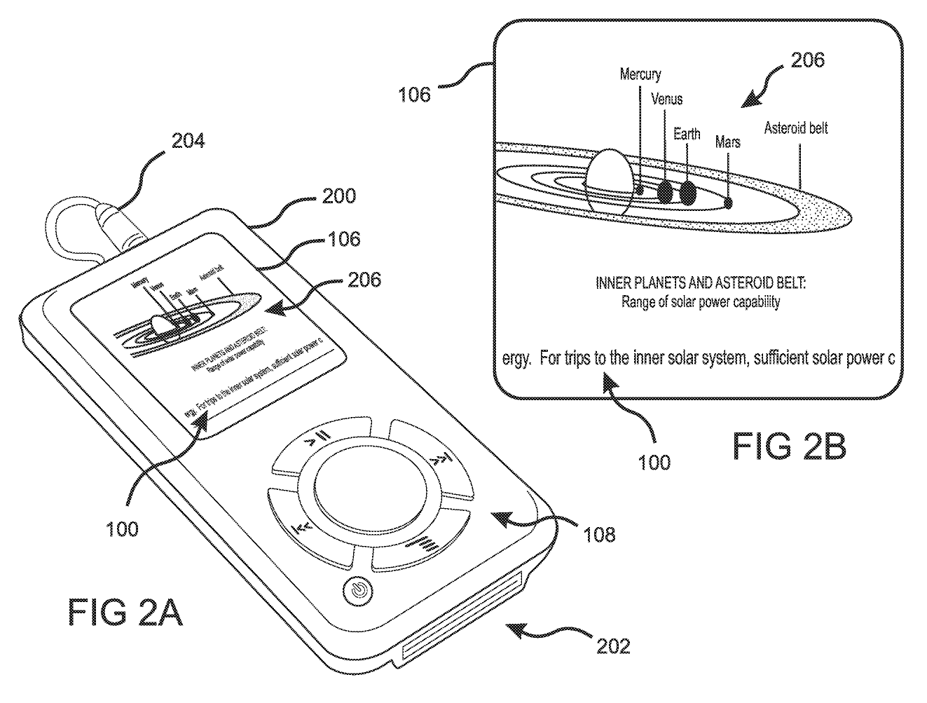

In the embodiment of FIG. 2A the electronic device 200 is an MP3 player that includes a port 202 for direct connection to a computer, as well as a port 204 for connecting headphones. In this embodiment, the computer port 202 can be used for directly downloading reading materials into the MP3 player. The headphones 204 can be used for listening to music that can be independent of the reading materials or can be coordinated with the reading materials so as to enhance their effectiveness, in a manner similar to the way in which soundtracks are used to enhance television shows and movies. In some embodiments, the headphones 204 are also used to present a vocal recitation of the words being presented on the display 106, for example to help a user to learn to read or as an aid in learning a second language.

In FIG. 2A, the MP3 player 200 is being used to present an article on astronomy from a scientific magazine, together with a video presentation 206 showing the movements of the planets in the solar system. A close-up view of the display 106 of the MP3 player 200 is shown in FIG. 2B.

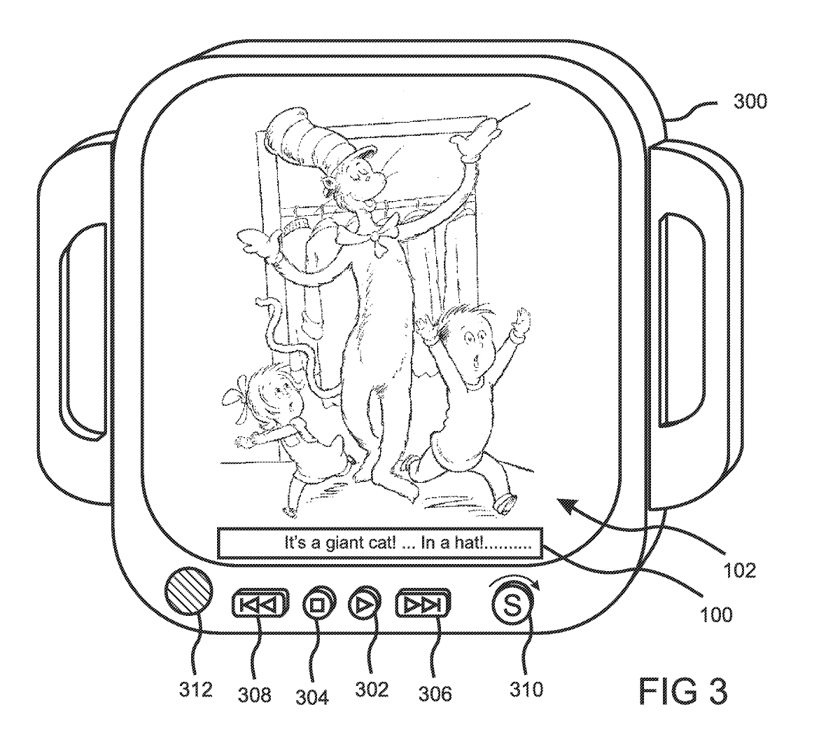

In some embodiments, the present invention includes an electronic device that displays the text and related images. FIG. 3 illustrates a portable device 300 of an embodiment of the present invention that is optimized for use by children, both for entertainment and for assisting children in learning to read. In the embodiment of FIG. 3, physical controls are provided on the electronic device 300 for controlling presentations on the display 106. These include controls to play 302, stop 304, fast forward 306, and reverse 308. In addition, a knob 310 is provided for adjusting the speed at which the text is scrolled, and a speaker 312 built into the device can be used to audibly present the text as it is scrolled across the screen, thereby further helping a child to learn to read.

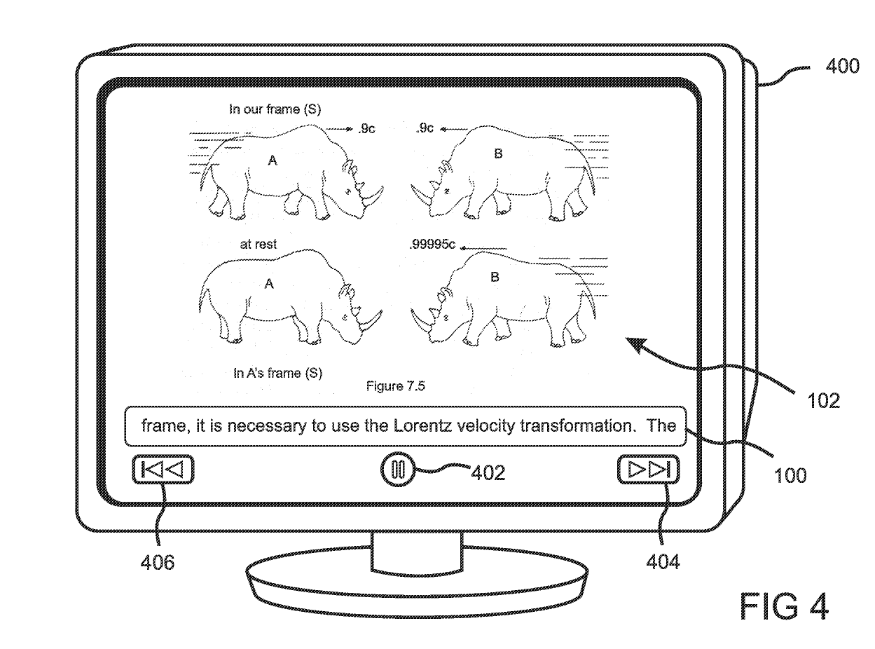

FIG. 4 illustrates an embodiment that of the present invention implemented on a conventional computer. Text 100 from a scientific textbook is scrolled across the bottom of the computer display 400, while a corresponding scientific diagram 102 is displayed above the text 100. As the text 100 is displayed, corresponding elements in the diagram 102 are highlighted, so as to further clarify the meaning of the presented text 100.

Other modifications and implementations will occur to those skilled in the art without departing from the spirit and the scope of the invention as claimed. Accordingly, the above description is not intended to limit the invention except as indicated in the following claims.

What is claimed is:

1. A system for displaying text and associated images, the system comprising:
media containing software that is able to control the actions of an electronic device so as to cause the electronic device to:
store reading materials in a memory contained in the electronic device, the reading materials including text and at least one graphical image pertaining to the text;
display the text on a display of the electronic device, the text being displayed as a scrolling single line of text; and
display the at least one graphical image on the display of the electronic device, the at least one graphical image being displayed while text pertaining thereto is simultaneously being displayed.

2. The system of claim 1, wherein the electronic device is a portable electronic device.

3. The system of claim 1, wherein the electronic device is at least one of:
a desktop computer;
a laptop computer;
a hand-held computer;
a cell phone;
a GPS;
a smart phone;
a game console;
a DVD player; and
an MP3 player.

4. The system of claim 1, wherein the electronic device is able to communicate with other devices over a network.

5. The system of claim 4, wherein the network is one of a local network, the publicly switched telephone network, and the internet.

6. The system of claim 4, wherein the electronic device is able to communicate wirelessly with other devices.

7. The system of claim 4, wherein the software is able to cause the electronic device to at least one of:
download reading materials from another device, and
upload reading materials to another device.

8. The system of claim 1, wherein the electronic device is able to display the at least one graphical image in color.

9. The system of claim 1, wherein the at least one graphical image is one of:
a still image; and
a video image.

10. The system of claim 1, wherein the scrolling single line of text is displayed horizontally across a bottom of the display.

11. The system of claim 1, wherein the scrolling single line of text is displayed substantially across a top of the display.

12. The system of claim 1, wherein the software provides user control of at least one of:
a rate of text scrolling;
a text font size;
a text font style; and
a text color.

13. The system of claim 1, wherein the software provides for user control of at least one of:
initiating scrolling of the text;
pausing scrolling of the text;
halting scrolling of the text;
causing the text to scroll rapidly forward;
causing the text to scroll rapidly backward;
searching the text for a specified word;
searching the text for a specified phrase;
highlighting text; and
setting a bookmark at a location in the text so as to enable easy return to the location.

14. The system of claim 1, wherein the software enables a user to select an item of text for at least one of:
display;
storing in the memory;
deletion from the memory; and
sharing with another electronic device.

15. The system of claim 1, further comprising an electronic device, the software being able to control the actions of the electronic device.

16. The system of claim 15, wherein the electronic device is portable.

17. The system of claim 15, wherein the electronic device is optimized for use by children.

18. The system of claim 1, wherein the software is able to cause the electronic device to present audible output in coordination with display of the text.

19. The system of claim 18, wherein the audible output is at least one of:
music unrelated to the text;
music coordinated with the text and tending to enhance the effectiveness of the text; and
an audible presentation of the text coordinated with the visual presentation of the text.
